(19) United States
(12) Patent Application Publication
(10) Pub. No.: US 2012/0042704 A1
(43) Pub. Date: Feb. 23, 2012

(54) CASH BOX

(75) Inventors: WEI-YU CHANG, New Taipei City (TW); Wei-Chih Chang, New Taipei City (TW)

(73) Assignee: SHYH RU METALLIC INDUSTRIAL CORP., New Taipei City (TW)

(21) Appl. No.: 13/214,552

(22) Filed: Aug. 22, 2011

Related U.S. Application Data
(60) Provisional application No. 61/376,218, filed on Aug. 23, 2010.

(51) Int. Cl. E05B 65/52; E05B 47/00

(52) U.S. Cl. 70/63

(57) ABSTRACT

An electronic cash box including a body, a cover and a panel set is provided. The cover is pivotally connected to the body, and provides an open state and a closed state. The panel set includes a keypad module providing an electronic lock function and a lock module providing a mechanical lock function. By operating either the keypad module or the lock module, the open state and closed state can be switched.

### FIELD OF THE INVENTION

The present invention relates to a safety box apparatus, and more particularly, to an electronic cash box.

### BACKGROUND OF THE INVENTION

Conventional safety boxes are mostly locked by mechanical means, and can only be opened by a key that is carried by a user at all times. Further, for electronic safety boxes locked by electronic passwords, it is necessary that a user remember a password set by oneself so that a safety box can be opened by pressing number keys.

### SUMMARY OF THE INVENTION

It is an objective of the present invention to provide an electronic cash box, which offers dual functions of electronic password and mechanical locks to optimize utilization flexibilities.

It is another objective of the present invention to provide an electronic cash box, which covers a keyhole of a mechanical lock when the mechanical lock is not in use to offer both security and esthetic effects.

To achieve the objectives above, the present invention provides a cash box comprising: a body; a cover, pivotally connected to the body to provide an open state and a closed state; and a panel set, embedded to a side of the body, comprising a keypad module and a lock module. Wherein, by operating either the keypad module or the lock module, the open state and the closed state can be switched.

According to the cash box according to the present invention, the panel set further comprises an opening for receiving a button comprising an extended section.

According to the cash box according to the present invention, a pair of almost parallel guiding tracks is further comprised at two sides of the opening The button is restrained to slide along a predetermined direction according to the guiding tracks.

According to the cash box according to the present invention, an solenoid valve is further comprised. The solenoid valve comprises a blocking section for pushing against the extended section of the button under the closed state.

According to the cash box according to the present invention, a positioning piece is further comprised for positioning the blocking section.

According to the cash box according to the present invention, the positioning piece comprises a non-magnetizing material.

According to the cash box according to the present invention, the button further comprises a projecting section slightly vertically extended outwards from the button.

According to the cash box according to the present invention, a concealing cover is further comprised for flexibly covering the lock module.

According to the cash box according to the present invention, a circuit board provided near the keypad module is further comprised, wherein the keypad module and the solenoid valve are electrically connected.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an elevational view of a cash box according to a preferred embodiment of the present invention.

FIG. 2 is a top view of the cash box in FIG. 1.

FIG. 3 is a side view of the cash box in FIG. 1.

FIG. 4 is a front view of a panel set.

FIG. 5 is a rear view of a panel set.

FIG. 6 is a partial enlarged view of a button.

### DETAILED DESCRIPTION OF THE PREFERRED EMBODIMENT

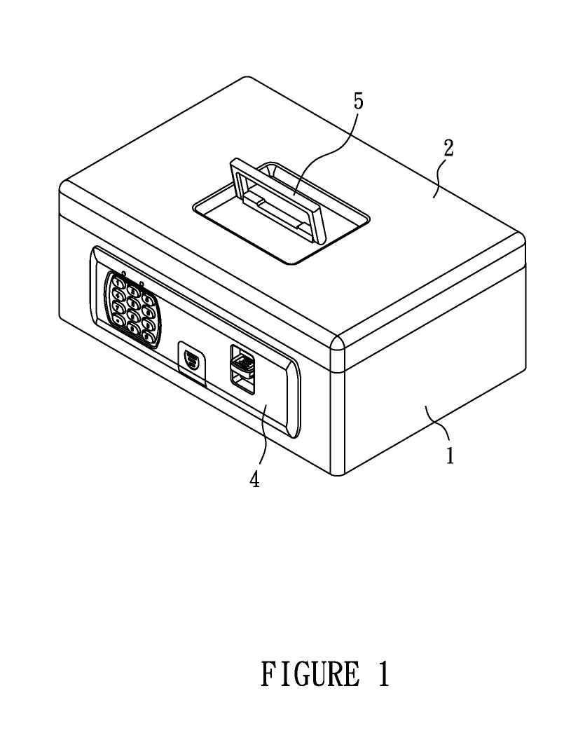

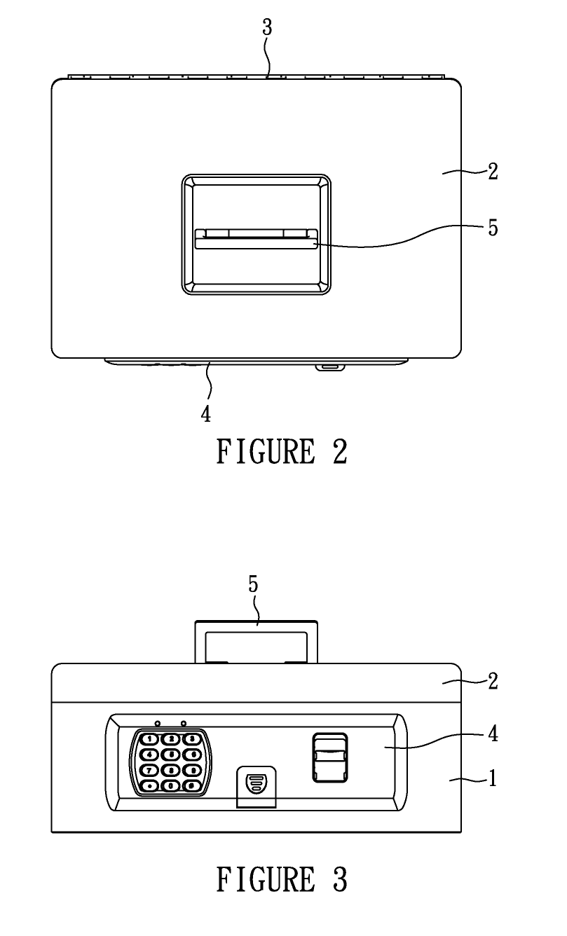

FIGS. 1, 2 and 3 respectively show an elevational view, a top view and a side view of an electronic cash box according to a preferred embodiment of the present invention. Referring to FIGS. 1 to 3, the electronic cash box according to a preferred embodiment of the present invention comprises a hollow body 1, a cover 2, a pivot 3, a panel set 4 and a handle 5. The cover 2 is pivotally connected to the body 1 via the pivot 3, so that the cover 2 is allowed to become a closed state or an open state relative to the body 1. Under a closed state, the cover 2 is closely engaged with the body 1 to prevent a risk of undesired peeping or undesired obtaining a content of the box, and so a shape of the cover 2 is necessarily formed to match a geometric shape of the body 1. Further, the cover 2 and the body 1, being rigid and endurable, are generally formed by a strong material such as metal or plastic steel.

Referring to FIGS. 1 to 3, the handle 5 is fixed to the cover 2, and allows grasping of a user so that the user may move or carry the cash box when the cover 2 is closed relative the body 1. Further, the panel set 4, embedded to one side of the body 1, comprises a keypad and a lock for allowing a user to open or close the cash box. The keypad and the lock shall be described below.

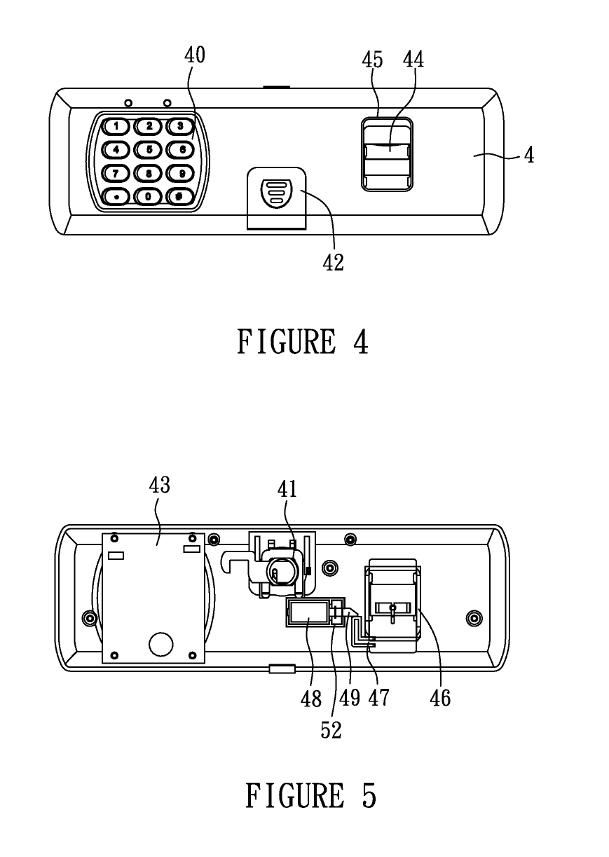

FIGS. 4 and 5 respectively show a front view and a rear view of the panel set 4. As shown, the panel set 4 comprises a keypad module 40, a lock module 41, an solenoid valve 48, and a button 44. The key module 40 comprises numeral buttons of 0 to 9, and symbol keys of “*” and “#”, and is electrically connected to a circuit board 43. Preferably, the circuit board 43 is provided closely to a rear side of the keypad module 40, such that the circuit board 43 is facilitated to receive a corresponding electronic signal when a user presses the number keys or symbol keys of the keypad module 40. The solenoid valve 48 comprises a blocking section 49 extended from one side of the solenoid valve 48. Further, the solenoid valve 48 is electrically connected to the circuit board 43 and is controlled by circuits on the circuit board 43. When a password entered by a user is correct, the solenoid valve 48 withdraws the blocking section 49 inwards via controls of the circuits on the circuit board 43. To coordinate with the blocking section 49, a positioning piece 52 is provided for positioning Further, to prevent a drawback that the blocking section 49 may fail to restore to its original position when electricity is cut off after magnetization occurring at an electrically connected axis of the blocking section 49 of the solenoid valve 48, the positioning piece 52 is made of a non-magnetizing material. Preferably, the positioning piece 52 may be made of plastic, or a plastic piece is enclosed around the positioning piece 52 to prevent the issue of position restoring failure of the blocking section 49 caused by magnetization.

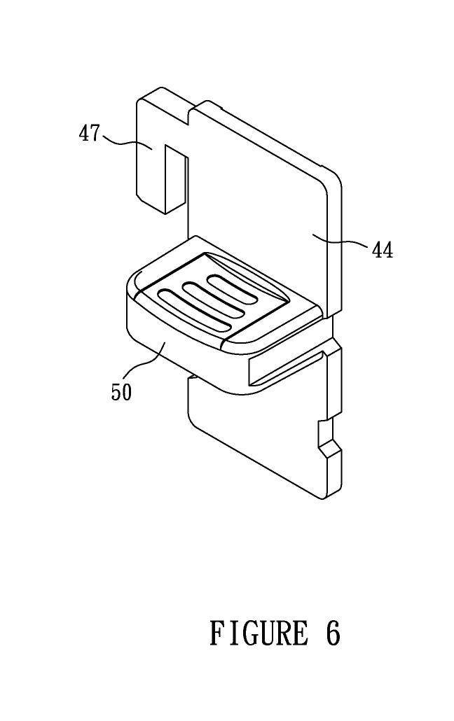

The panel set 4 further comprises an opening 45, and a pair of guiding tracks 46 (as shown in FIG. 6) in the opening 45 to receive the button 44, such that the button 44 is slidable according to the restraints of the guiding tracks 46 along a predetermined direction. The button 44 is provided with a projecting section 50 vertically extended outwards therefrom. The projecting section 50 is used for receiving the force pressed by a user. The button 44 further comprises an extended section 47 extended from one side of the button 44 that is near the solenoid valve 48. When the cash box is under the closed state, the blocking section 49 of the solenoid valve 48 pushes against the extended section 47 of the button 44 such that the button 44 is prohibited from sliding downwards. When a password entered by a user is correct, via controls of the circuits on the circuit board 43, the solenoid valve 48 withdraws the blocking section 49 inwards to allow the cash box to become the open state. In addition, the button 44 also becomes slidable since the blocking section 49 is withdrawn inwards. FIG. 6 shows a partial enlarged view of the button 44.

Further, with the lock module 41 of the cash box of the present invention, a user may still open the cash box with a key as an alternative solution in the event that a user forgets the password and cannot open the cash box through the keypad module 40. Since the opening of the cash box with the lock module 41 is rather an alternative solution which may not be utilized most of the time, a concealing cover 42 is provided to cover the lock module 41 for security and esthetic considerations when the lock module 41 is not in use. When a user needs to open the lock module 41, the concealing cover 42 may be moved by sliding to reveal the keyhole of the lock module 41 to allow a user to insert the key.

Therefore, the cash box of the present invention provides dual functions of an electronic lock and a mechanical lock to optimize utilization flexibilities. Further, when the mechanical lock is not in use, the keyhole of the mechanical lock is covered to further offer security and esthetic effects.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A cash box, comprising:
a body;
a cover, pivotally connected with the body to render an open state and a closed state;
a panel set, embedded to one side of the body, comprising a keypad module and a lock module, for switching between the open state and the closed state being performed by manipulating either the keypad module or the lock module.

2. The cash box as claimed in claim 1, wherein the panel set further comprises an opening for receiving a button comprising an extended section.

3. The cash box as claimed in claim 2, further comprising a pair of substantially parallel guiding tracks at two sides of the opening for restraining the button to slide along a predetermined direction.

4. The cash box as claimed in claim 2, further comprising an solenoid valve comprising a blocking section, the block section pushing against the extended section of the button under the closed state.

5. The cash box as claimed in claim 4, further comprising a positioning piece for positioning the blocking section.

6. The cash box as claimed in claim 5, wherein the positioning piece comprises a non-magnetizing material.

7. The cash box as claimed in claim 2, wherein the button further comprises a projecting section vertically extended outwards from the button.

8. The cash box as claimed in claim 1, further comprising a concealing cover for removably covering the lock module.

9. The cash box as claimed in claim 1, further comprising a circuit board provided near the keypad module and being electrically connected with the solenoid valve.
